(19) United States
(12) Patent Application Publication
(10) Pub. No.: US 2008/0162229 A1
(43) Pub. Date: Jul. 3, 2008

(54) System and method for processing of clinical trial data for multiple clinical trials through associated trial ids

(76) Inventor: Steven D.P. Moore, Milton (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, omitted

(21) Appl. No.: 12/003,232

(22) Filed: Dec. 20, 2007

Related U.S. Application Data
(60) Provisional application No. 60/875,826, filed on Dec. 20, 2006.

(51) Int. Cl. G06Q 10/00

(52) U.S. Cl. 705/7

(57) ABSTRACT

A system and method for processing clinical trial data in a network communication environment according to a trial protocol. The trial protocol defining a plurality of data quality requirements and analysis functions for use in processing the clinical trial data, the method comprising: accessing a plurality of the trial protocols defining a plurality of respective clinical trials; receiving an update from the communication network for said trial protocol of the plurality of trial protocols, the update for amending at least one of the data quality requirements or analysis functions; receiving a trial dataset from the communication network having a trial ID for identifying at least one of the plurality of the trial protocols, the trial dataset including patient image data and identification data for at least one originator of the patient image data; matching the trial ID to the updated trial protocol from said plurality of trial protocols and selecting the updated trial protocol for use in processing the received trial dataset; determining through a data processing module a deficiency in the patient images of the received trial dataset as contradicting at least one of the data quality requirements or analysis functions of the updated trial protocol; and sending a request over the communications network for eventual receipt by the originator of the received trial dataset for a revised set of the received trial dataset, the request including information regarding the determined deficiency.

### BACKGROUND

There is a need for monitoring the adherence to standards for data acquisition and data processing of data related to clinical trials. Further, there is a need for facilitating the operation of a data analysis system for accepting clinical trial data relating to more than one clinical trial, as well as for matching anonymized image data with anonymized textual data relating to a specific patient.

### SUMMARY

The systems and methods disclosed herein provide a clinical trial data processing environment to obviate or mitigate at least some of the above-presented disadvantages.

A first aspect provided is a method for processing clinical trial data in a network communication environment according to a trial protocol, the trial protocol defining a plurality of data quality requirements and analysis functions for use in processing the clinical trial data, the method comprising: accessing a plurality of the trial protocols defining a plurality of respective clinical trials; receiving an update from the communication network for said trial protocol of the plurality of trial protocols, the update for amending at least one of the data quality requirements or analysis functions; receiving a trial dataset from the communication network having a trial ID for identifying at least one of the plurality of the trial protocols, the trial dataset including patient image data and identification data for at least one originator of the patient image data; matching the trial ID to the updated trial protocol from said plurality of trial protocols and selecting the updated trial protocol for use in processing the received trial dataset; determining through a data processing module a deficiency in the patient images of the received trial dataset as contradicting at least one of the data quality requirements or analysis functions of the updated trial protocol; sending a request over the communications network for eventual receipt by the originator of the received trial dataset for a revised set of the received trial dataset, the request including information regarding the determined deficiency.

### BRIEF DESCRIPTION OF THE DRAWINGS

These and other features will become more apparent in the following detailed description in which reference is made to the appended drawings wherein:

FIG. 1 is a block diagram of a communication network system for clinical trials;

FIG. 2 is an example workflow of the clinical trial of FIG. 1; and

FIG. 3 is a block diagram of a generic computing device for implementing operations of the workflow of FIG. 2.

### DESCRIPTION

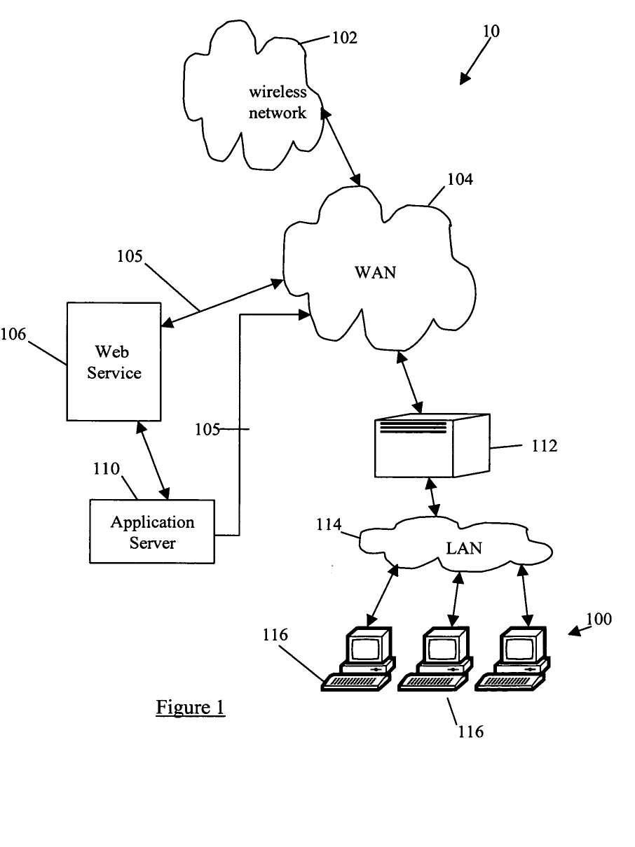

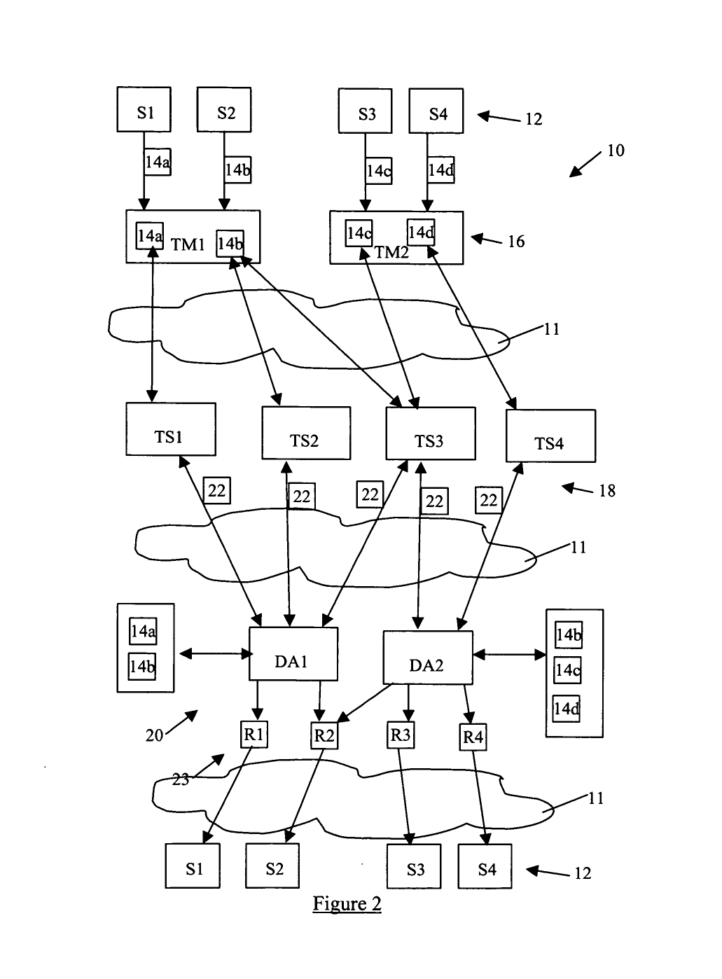

Referring to FIG. 1, a communication network system 10 comprises a plurality of trial sponsors 12 (e.g. different sponsors S1, S2, S3, S4) for supporting a plurality of respective clinical trials involving data obtained from a plurality of trial eligible patients/subjects 100 (see FIG. 2). The trial sponsors 12 are responsible for defining the clinical trials by specifying implementation considerations and financial considerations of the clinical trials through corresponding trial protocols 14a,b,c,d, the considerations being such as but not limited to: characteristics and requirements that determine operation of data quality control functions within the system 10; operational procedures of data acquisition (e.g. authorized imaging systems) in predetermined format(s); desired reporting 23 of the clinical trial results and methods of data analysis; and type and quantity of data desired (e.g. images of selected anatomy regions, answers to selected questions, measured clinical parameters such as blood pressure and age/sex, etc.). The sponsors 12 can use the services of a trial manager 16 (e.g. TM1, TM2) for managing the implementation of trial protocols 14a,b,c,d, including: selection of one or more trial sites 18 (e.g. TS1, TS2, TS3, TS4) for collection of the data for specific clinical trials under the jurisdiction of the respective trial manager 16; and selection of one or more data analysis sites 20 (e.g. imaging core labs), such as DA1 and DA2, for analysis of collected trial data 22 received from the trial sites 18. The trial sites 18 can be such as but not limited to clinics, hospitals, and other health care facilities with appropriate technical infrastructure to acquire the trial data 22. The data analysis sites 20 are responsible for processing the each of the collected trial data 22 according to the respective trial protocol 14a,b,c,d in order to generate a respective trial report (e.g. R1, R2, R3, R4), as further described below. Accordingly, it is recognized that one data analysis site 20 can be responsible for analyzing (and reporting on) trial data 22 received for multiple different clinical trials. It is recognized that the trial managers 16, the trial sites 18, and the data analysis sites 20 can be interconnected by a network 11, as desired.

Referring to FIG. 2, shown is an example workflow of the network system 10 for a selected combination of trial sponsor 12, trial manager TM1, trial site TS1, and data analysis site DA1. The sponsor 12 decides upon the general operating parameters of the trial protocol 14a and provides this to the trial manager TM1, which stores 100 the trial protocol 14a (with other trial protocols 14b,c,d where applicable). It is noted that the trial manager TM1 may be responsible for one or more trials, as desired. The trial protocol 14a is labeled with a unique identifier 24, also referred to as a trial ID, in order to distinguish this trial from the other trials being conducted (for example by the trial manager TM1 or other managers 16 as desired). The trial manager TM1 selects 102 the trial site TS1 (and others as desired) to be used for collection of the trial data 22 required by the trial protocol 14a. Once selected, the trial manager TM1 can provide training for the selected trial site TS1 in order to help ensure (e.g. using a certification process) that the trial site TS1 personnel and data collection facilities are adequate/enabled 104 for acquiring the required trial data 22 (i.e. according to the trial protocol 14a).

Once enabled, the trial site TS1 acquires 106 data patient data 27 from eligible patients 26 (including patient image and/or patient non-image data) in view of the trial protocol 14a (e.g. facilitates quality control of the image and textual patient data 27) and assigns the corresponding trial ID 24 to the collected patient data 27. It is recognized that the patient data 27 can contain both personal data 28 (e.g. patient name, patient identifier, patient address, patient contact information, patient medical insurance information, healthcare provider identification information, and other information usable to help uniquely identify the particular patient used to collect the patient data 27) and general or non-specific data 30 (e.g. medical images, answers to trial questionnaires, and other information that cannot be used to help uniquely identify the particular patient and/or health care provider used to collect the patient data 27). The trial site TS1 can use various imaging modalities (CT, MR, X-ray, ultra-sound, etc.) and imaging procedures and parameters that will produce patient images in an acceptable manner as specified in the trial protocol 14a. The use of a consistent set of parameters as specified in the trial protocol 14a facilitates comparability of the images and textual data within a clinical trial. It is recognized that the acquired images in the patient data 27 are suitable for storage in a digital format (also definable by the trial protocol 14a as desired). Further, it is recognized that the textual portion of the patient data 27 is also suitable for storage in a digital format (also definable by the trial protocol 14a as desired).

The trial site TS1 also anonymizes 108 (using automatic data parsing, manual data parsing, or a combination thereof) the patient data 27 collected in order to remove or otherwise obscure (e.g. renders the patient identity anonymous) all of the personal data 28 while retaining the non-specific data 30 required by the trial protocol 14a. Once anonymized, the patient data 27 becomes the clinical trial data 22. It is recognized that the trial ID 24 can be attached to the patient data 27, the personal data 28, the non-specific data 30, the clinical trial data 22, or a combination thereof and the data 27,28, 30, 22 with associated trial ID 24 can be stored 110 in storage of the trial site TS1. It is recognized that the specific manner in which the patient data 27 is anonymized can be defined in the trial protocol 14a, as desired. The anonymization process can include operations (defined in the trial protocol 14a) such as but not limited to: removal of data fields from the patient data 27 that are part of image header; substitution of data values in the patient data 27 based on controlled vocabularies; and/or removal or substitution of data in patient images.

Further, it is recognized that the clinical trial data 27 can also be assigned a file ID (e.g. at the anonymizer step 108) that can be used to track selected clinical trial data 27 for selected patients or groups of patients who have been anonymized. Further, it is recognized that a trial site ID can be assigned (e.g. at the storage step 110) to the clinical trial data 27 for facilitating monitoring of performance of the individual trial sites 18 used to generate the clinical trial data 27. Any of the IDs can be included with the trial data 22 that is communicated or otherwise made available to the data analysis sites 20, as desired.

The trial data 22 (with attached trial ID 24) is then sent 112 over the network 11 (e.g. an intranet or an extranet such as the Internet) to the remote data analysis site 20 in order for analysis of the non-specific data 30 included in the clinical trial data 22. Once received, the trial data 22 (containing image and non-image data if desired by the trial protocol 14a) is reviewed 114 to automatically identify the included trial ID 24, and then the trial data 22 is assigned to the respective clinical trial (i.e. the trial data 22 is matched with the appropriate trial protocol 14a). It is recognized that the trial data 22 can be received from multiple different trial sites 18. Accordingly, the data analysis site 20 can: select the appropriate trial protocol 14a (in this case) from a plurality of known trial protocols stored locally at the data analysis site 20; access the appropriate trial protocol 14a via a network address associated with the trial ID 24 (e.g. request the trial protocol 14a from the trial manager TM1 over the network 11 using the network address); or a combination thereof. It is recognized that the review process 114 of the received trial data 22 can also be used to examine the trial data 22 for quality control purposes (also potentially defined by the trial protocol 14a), as further described below.

Once the appropriate trial protocol 14a is known for the received trial data 22, the trial data 22 is set-up/prepared 116 for reading/analysis 118 by trained analysts 31, in order to facilitate consistency of the trial data 22 for the reading 118 step. The preparation 116 of the clinical trial data 22 can include actions such as but not limited to: image zoom; image pan; selected image views; image measure; cropping specific regions of interest from larger imaged regions of the patient 26; other standardization operations of included patient images (e.g. specified image sizes, image orientations, image enhancements); associate a randomized ID for the included image(s); and/or put included textual information obtained from the patient (age, sex, questionnaire answers, etc.) into a desired format. It is recognized that the specific manner in which the received trial data 22 is prepared 116 can be defined in the trial protocol 14a, as desired. Further, it is recognized that specific procedures/protocols in processing the format of the data 22 for the preparation step 116 can be different from the procedures used to format the acquired data 27 at step 106, thus demonstrating the dynamic updatable nature of the trial protocol 14a to change the emphasis on certain portions of the data 22 during conducting of the respective clinical trial (e.g. changes to the protocol 14a occur after the trial site 18 has been trained 104 or has otherwise produced the data 27).

It is also recognized that the steps 114 and/or 116 could log their findings on the quality and/or timeliness of the received data 22, for example in comparison with the trial protocol 14a, including the content and frequency of the messages 122,123 to the trial site 18, and thus monitor the performance of the individual trial sites 18 with respect to the received data 22. The data analysis site 20 could decide which trial site(s) 18 to accept the trial data 22 from based on the determined performance of the trial sites 18.

Once the trial data 22 has been prepared 116, the analysts 31 analyze 118 the trial data 22 according to the trial protocol 14a, in order to complete the reports 23 generated 120 according to report definitions included in the trial protocol 14a. This analysis 118 step is used to identify desired clinical information from the trial data 22 and to include this desired clinical information in the reports 23, e.g. analyze the trial data 22 to select and determine parameters for use in evaluating progress of the clinical trial. Further, the analysis 118 can include conducting statistical analysis of the trial data 22 according to predefined statistical analysis parameters in the trial protocol 14a.

In the generation 120 of the reports 23, it is recognized that the desired clinical information, and desired report format thereof, is defined in the trial protocol 14a. The analysts 30 can be human (e.g. effecting a manual analysis of the prepared clinical trial data 22) according to a predefined set of analysis procedures/steps; an analysis software (e.g. effecting an automated analysis of the prepared clinical trial data 22); or a combination thereof.

Accordingly, in view of the above described example operation of the network system 10, it is recognized that the inclusion of the trial ID 24 in the trial data 22 facilitates automatic recognition by the data analysis site 20 of which clinical trial the trial data 22 should be associated with. In this capacity, any data analysis site 20 can be configured for processing of trial data 22 obtained from multiple trial sites 18, which are used for multiple respective clinical trials. Through the trial ID 24, the data analysis site 20 matches the appropriate trial protocol 14a,b,c,d to the trial data 22, in order to assist in appropriate processing of the trial data 22 to result in desired reports 23 intended for review by the respective trial sponsor 12. It is recognized that the trial protocol 14a,b,c,d corresponding to the received trial data 22 can be communicated to the data analysis site 20 during setup of the clinical trial (e.g. the data analysis site 20 is selected by the trial manager 16) and/or remotely accessed over the network 11 in response to identifying the corresponding trial ID from the received trial data 22. It is recognized that the trial manager 16 can also communicate (or otherwise make available) synchronously and/or asynchronously any updates of the trial protocol 14a,b,c,d to the sites 18, 20, as desired, including predefined parameters for coordinating standardized data acquisition and data processing by the trial site TS1 and the data analysis site DA1 as noted above.

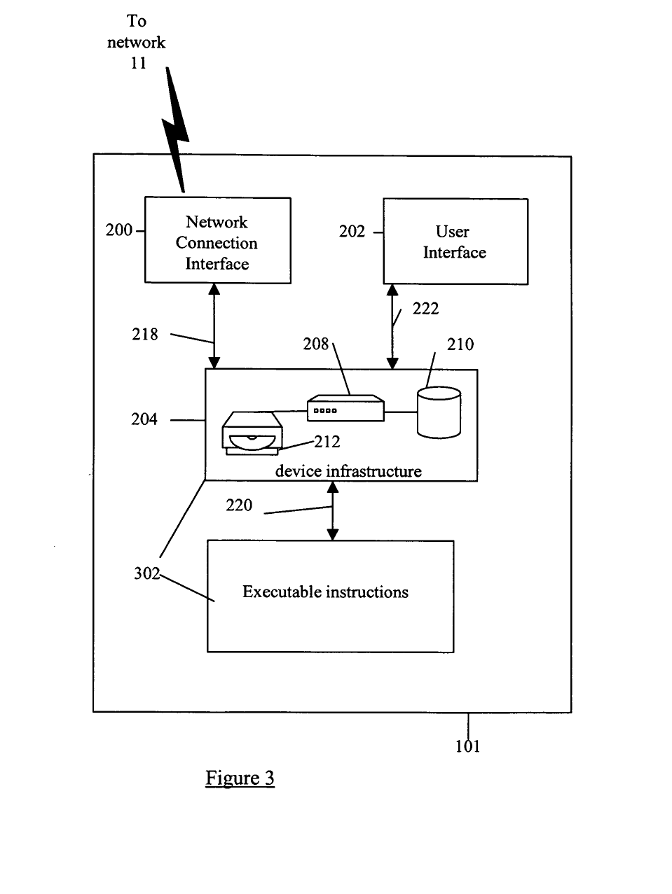

Referring to FIG. 3, each of the above-described operations 106, 108, 110, 112, 114, 116, 118, 120 can be implemented on a respective computing device 101. The devices 101 in general can include a network connection interface 200, such as a network interface card or a modem, coupled via connection 218 to a device infrastructure 204. The connection interface 200 is connectable during operation of the devices 100 to the network 11, which can enable the devices 101 to communicate with each other, the sponsor 12, and the trial manager 16, as appropriate. The network 11 supports the transmission of the trial data 22 between the sites 18, 20, the reports 23 between the data analysis site 20 and the sponsor 12 (or trial manager 16), the trial protocol 14a,b,c,d (and any updates/changes thereto) between the sponsor 12 and the trial managers 16, as well as between the trial managers 16 and the sites 18,20.

Referring again to FIG. 2, the devices 101 also have a user interface 202, coupled to the device infrastructure 204 by connection 222, to interact with a user (not shown). The user interface 202 includes one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 204. The user interface 202 is employed by the user of the device 101 to coordinate the respective processing of data 27,22 at various stages of the above described clinical trial workflow (including data acquisition) as facilitated by application programs/hardware 302 configured to administer the respective portions of the trial protocols 14a,b,c,d for the respective operations 106, 108, 110, 112, 114, 116, 118, 120.

Referring again to FIG. 2, operation of the device 101 is enabled by the device infrastructure 204. The device infrastructure 204 includes a computer processor 208 and an associated memory module 210. The computer processor 208 manipulates the operation of the network interface 200, the user interface 202 and the application programs/hardware of the device 101 by executing related instructions, which can be provided by an operating system located in the memory module 210. The computer processor 208 facilitates performance of the device 101 configured for the intended task (e.g. suitable modules/processors for the respective operations 106, 108, 110, 112, 114, 116, 118, 120) through operation of the network interface 200, the user interface 202 and other application programs/hardware of the device 101 by executing task related instructions. These task related instructions can be provided by the operating system, and/or software applications (e.g. executable instructions 302) located in the memory 210, and/or by operability that is configured into the electronic/digital circuitry of the processor(s) 208 designed to perform the specific task(s). Further, it is recognized that the device infrastructure 204 can include a computer readable storage medium 212 coupled to the processor 208 for providing instructions to the processor 208 and/or to load/update client application programs 302 in the memory module 210. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 210. It should be noted that the above listed example computer readable mediums 212 can be used either alone or in combination.

Further, it is recognized that the computing devices 101 can include an executable application program 302 comprising code or machine readable instruction for implementing predetermined functions including those of an operating system, healthcare information system or other information processing system, for example, in response user command or input as defined by the appropriate trial protocol 14a,b,c,d (for example). The processor 208 as used herein is a device and/or set of machine-readable instructions 302 for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information to an output device. The processor 208 may use or comprise the capabilities of a controller or microprocessor, for example. Further, any of the functions provided by the systems and process of FIGS. 1-2 may be implemented in hardware, software or a combination of both. Accordingly, the use of a processor 208 as a device and/or as a set of machine-readable instructions 302 is hereafter referred to as the processor for sake of simplicity.

It will be understood by a person skilled in the art that the storage/database 210 of the computer devices 101 (as well as any communal storage—not shown—for any of the trial sites 18 and/or data analysis sites 20) described herein is the place where data is held in an electromagnetic or optical form for access by a computer processor. There are a number of different embodiments: One, can mean the devices and data connected to the computer through input/output operations such as hard disk and tape systems and other forms of storage not including computer memory and other in-computer storage. Second, in a more formal usage, storage can been divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be much faster to access than secondary storage because of the proximity of the storage to the processor or because of the nature of the storage devices. On the other hand, secondary storage can hold much more data than primary storage. In addition to RAM, primary storage can include read-only memory (ROM) and L1 and L2 cache memory. In addition to hard disks, secondary storage can include a range of device types and technologies, including diskettes, Zip drives, redundant array of independent disks (RAID) systems, and holographic storage. Devices that hold storage are collectively known as storage media.

A database is a further embodiment of storage as a collection of information that is organized so that it can easily be accessed, managed, and updated. In one view, databases can be classified according to types of content: bibliographic, full-text, numeric, and images. In computing, databases are sometimes classified according to their organizational approach, such as a relational database being a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Computer databases can contain aggregations of data records or files, such as sales transactions, product catalogs and inventories, and customer profiles. Typically, a database manager of the storage provides users the capabilities of controlling read/write access, specifying report generation, and analyzing usage. Databases and database managers are prevalent in large mainframe systems, but are also present in smaller distributed workstation and mid-range systems such as the AS/400 and on personal computers (e.g. devices 101). SQL (Structured Query Language) is a standard language for making interactive queries from and updating a database such as IBM's DB2, Microsoft's Access, and database products from Oracle, Sybase, and Computer Associates.

Memory is a further embodiment of the storage as the electronic holding place for instructions and data that the computer's microprocessor can reach quickly. The memory of the computer can contains the main parts of the operating system and some or all of the application programs (e.g. instructions 302) and related data that are being used. Memory can be used as a shorter synonym for random access memory (RAM). This kind of memory is located on one or more microchips that are physically close to the microprocessor in the computer devices 101.

Further, it is recognized that the trial sites 18 and the data analysis sites 20 can be configured to communicate with one another and can have configured access to each others storage for interaction with the stored clinical data directly, if desired. For example, the trial ID assigned to a particular data set can also have a data indicator identifying the particular memory address of the respective storage containing the particular data set. Accordingly, any requested updates to the particular data set (e.g. due to inadequate formatting, missing information, etc.) conducted inter- and/or intra-site 18,20 can be coordinated.

Further, it is recognized that the computer devices 101 can contain processors/modules for implementing all steps included in the operations 106, 108, 110, 112, 114, 116, 118, 120. as desired.

Specifically, the computing device 101 used to implement the data acquisition step 106 by the trial site 18 can include a trial user interface 202 as defined by the respective trial protocol 14a,b,c,d. The trial user interface 202 would be configured for facilitating operation of coupled imaging devices (not shown) and other devices (not shown) used in data acquisition. The trial user interface 202 provides a standard image layout and set of user functions (that may be restricted and/or simplified by the trial protocol 14a,b,c,d provided to the trial site 18. The use of the trial user interface 202 can facilitate quality control of generating the trial data 22, through standard operating procedures employed in image acquisition, and consistent pricing information set for use by the trial sites 18.

Specifically, the computing device 101 used to implement the trial data 22 review process 114 by the data analysis site 20 can include a quality control processor 208 to help facilitate quality of clinical images and textual data, for example. For this purpose, the quality control processor 208 automatically monitors image quality in the trial data 22, the degree of compliance with predetermined standards and the degree of compliance with predetermined procedures of the trial protocol 14a,b,c,d as it pertains to image content and format. Further, the quality control processor 208, in response to an automatically determined deficiency of the images of the trial data 22, can automatically initiate generation of an alert message 122 to the trial site 18 and can automatically initiate preliminary remedial action to correct the determined deficiency. This message 122 can be communicated to the image acquisition 106 device, in order to request a revised set of the trial data 22.

Specifically, the computing device 101 used to implement the trial data 22 preparation operation 116 by the data analysis site 20 can include a preparation processor 208 to help facilitate further quality of clinical images and textual data, for example. For this purpose, the preparation control processor 208 facilitate monitoring of image quality of the trial data 22 interactively with a user of the computing device (via the user interface 202). The preparation processor 208 can help determine the degree of compliance with predetermined standards and the degree of compliance with predetermined procedures of the trial protocol 14a,b,c,d as it pertains to image content and format. The preparation operation 116 is facilitated by the preparation processor 208 (e.g. automatic, manual, or a combination thereof) to perform sanity checks of the trial images, to verify the trial data 22 anonymization, and to otherwise approve the trial data 22 for further processing by the reading operation 118. The preparation processor 208 can be configured to interact with the user (via the user interface 202): to visualize received images (of the trial data 22) to verify anonymization correctness (the original images may be downloaded from the trial site 18 for comparison; if no problems have been found the trial data 22 is approved as verified images for the reading 118 operation (e.g. the trial data 22 is then put on the reader's queue list of trail data 22 to analyze); and if problems have been found the user notifies the remote trial site 18 using a notification message 123 about images or other data that either did not pass the sanity check or that the anonymization was incorrect. This message 123 can be communicated to the image acquisition 106 and/or anonymization device(s), in order to request a revised set of the trial data 22.

Further, it is recognized that the communication of the messages 122,123 (and others) between the trial site 18 and the data analysis site 20 can be done by respective communication modules (not shown), which would be responsible for transmitting/receiving the messages 122,123 between the sites 18,20, as well as distributing and received messages 122,123 (or responses thereto) to the respective device within the site 18,20. For example, the trial site communication module could receive a message 123 from the data analysis site communication module, determine from the message 123 contents (with consultation with the trial protocol 14a if needed) what corrective steps are required to satisfy the message 123 (e.g. improper anonymization), and then send the message 123 to the appropriate operation (e.g. the anonymization 108 step).

We claim:

1. A method for processing clinical trial data in a network communication environment according to a trial protocol, the trial protocol defining a plurality of data quality requirements and analysis functions for use in processing the clinical trial data, the method comprising:
accessing a plurality of the trial protocols defining a plurality of respective clinical trials;
receiving an update from the communication network for said trial protocol of the plurality of trial protocols, the update for amending at least one of the data quality requirements or analysis functions;
receiving a trial dataset from the communication network having a trial ID for identifying at least one of the plurality of the trial protocols, the trial dataset including patient image data and identification data for at least one originator of the patient image data;
matching the trial ID to the updated trial protocol from said plurality of trial protocols and selecting the updated trial protocol for use in processing the received trial dataset;
determining through a data processing module a deficiency in the patient images of the received trial dataset as contradicting at least one of the data quality requirements or analysis functions of the updated trial protocol; and
sending a request over the communications network for eventual receipt by the originator of the received trial dataset for a revised set of the received trial dataset, the request including information regarding the determined deficiency.

2. The method of claim 1, wherein the data processing module is a preparation module for preparing the trial dataset configured for preparing the trial dataset for a subsequent data analysis according to the data analysis functions of the updated trial protocol.

3. The method of claim 1, wherein the data processing module is a data analysis module configured for validating the quality of the trial dataset according to the data quality requirements of the updated trial protocol.

4. The method of claim 2 further comprising monitoring a number of the requests sent to the originator of the received trial dataset for calculating a performance measure of the originator of the received trial dataset.

5. The method of claim 1, wherein the updated trial protocol is different from the trial protocol used by the originator of the received trial dataset for collecting the patient image data.

6. The method of claims 3 further comprising monitoring a number of the requests sent to the originator of the received trial dataset for calculating a performance measure of the originator of the received trial dataset.
